(19) United States
(12) Patent Application Publication
(10) Pub. No.: US 2026/0178950 A1
(43) Pub. Date: Jun. 25, 2026

(54) DYNAMIC PARTITIONING OF CONTROL ELECTRONICS FOR QUANTUM COMPUTERS

(71) Applicant: International Business Machines Corporation, Armonk, NY (US)

(72) Inventors: Frank Haverkamp, Tuebingen (DE); Andre Avila Alves, Hamburg (DE); Tristan Müller, Tübingen (DE); Timothy Lindquist, Rochester, MN (US)

(21) Appl. No.: 18/754,092

(22) Filed: Jun. 25, 2024

(51) Int. Cl. G06N 10/40; G06N 10/20

(52) U.S. Cl. CPC G06N 10/40; G06N 10/20

(57) ABSTRACT

Qubits of a quantum system for use in executing a given quantum program of a plurality of quantum programs are determined. Control electronics associated with the determined qubits are determined and a set of partitions of the quantum system is determined based on an analysis of pending jobs. The qubits and the control electronics are allocated to the set of partitions of the quantum system based on the analysis of pending jobs and the quantum programs are run using the allocated qubits.

### BACKGROUND

The present invention relates generally to the electrical, electronic and computer arts and, more particularly, to quantum computers.

Conventionally, a small quantum job (quantum program), such as a job utilizing just two qubits, will occupy a full quantum system, such as a conventional quantum processor having, for example, over 400 qubits. Static repartitioning has been utilized in such cases, but it only partially addresses the problem. It is possible to subdivide such systems into n single quantum processors or a combination of the same, saving quantum computing resources and reducing the cost of running quantum processors. Generally, as quantum computers increase in size, new quantum systems will be deployed that are much larger than many of the quantum programs that are intended to be run on these systems. Such quantum systems are prime candidates for subdivision.

Conventional partitioning systems, however, are in general dealing with resources such as central processing units (CPUs), CPU-threads, and memory. The conventional partitioning of the conventional (classical) computing system is supported by additional hardware components such as memory management units (MMUs). Different hardware access protection layers built into the CPUs and threads are required to create, operate, and delete these partitions, which are normally embedded in the device providing the processing resources.

### BRIEF SUMMARY

Principles of the invention provide systems and techniques for dynamic partitioning of control electronics for quantum computers. In one aspect, an exemplary method includes the operations of determining qubits of a quantum system for use in executing a given quantum program of a plurality of quantum programs; determining control electronics associated with the determined qubits; determining a set of partitions of the quantum system based on an analysis of pending jobs; allocating the qubits and the control electronics to the set of partitions of the quantum system based on the analysis of pending jobs; and running the quantum programs using the allocated qubits.

In one aspect, a computer program product comprises one or more tangible computer-readable storage media and program instructions stored on at least one of the one or more tangible computer-readable storage media, the program instructions executable by a processor, the program instructions comprising determining qubits of a quantum system for use in executing a given quantum program of a plurality of quantum programs; determining control electronics associated with the determined qubits; determining a set of partitions of the quantum system based on an analysis of pending jobs; allocating the qubits and the control electronics to the set of partitions of the quantum system based on the analysis of pending jobs; and running the quantum programs using the allocated qubits.

In one aspect, a system comprises a memory and at least one processor, coupled to the memory, and operative to perform operations comprising determining qubits of a quantum system for use in executing a given quantum program of a plurality of quantum programs; determining control electronics associated with the determined qubits; determining a set of partitions of the quantum system based on an analysis of pending jobs; allocating the qubits and the control electronics to the set of partitions of the quantum system based on the analysis of pending jobs; and running the quantum programs using the allocated qubits.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a flowchart for managing incoming workloads and partitions to allow jobs (also

referred to as programs herein) to be executed efficiently, in accordance with an example embodiment;

FIG. 2A is a flowchart for a task that executes jobs in the dedicated queues per partition, in accordance with an example embodiment;

FIG. 2B is a flowchart for managing partitions of a quantum processor, in accordance with an example embodiment;

FIG. 3 is a flowchart for a first example method for partitioning a quantum computer, in accordance with an example embodiment;

FIGS. 4A-4B are a flowchart for a second example method for partitioning a quantum computer, in accordance with an example embodiment;

FIGS. 5A-5B are a flowchart for a third example method for managing partitions of a quantum processor, in accordance with an example embodiment; and

FIG. 6 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Given the discussion herein (reference characters refer to the drawings discussed below), it will be appreciated that in one aspect, an exemplary method, according to an aspect of the invention, includes the operations of determining qubits of a quantum system for use in executing a given quantum program of a plurality of quantum programs; determining control electronics associated with the determined qubits; determining a set of partitions of the quantum system based on an analysis of pending jobs; allocating the qubits and the control electronics to the set of partitions of the quantum system based on the analysis of pending jobs; and running the quantum programs using the allocated qubits. In example embodiments, network components of the quantum system for coupling the control electronics are determined. The technical benefits include improved system utilization, higher job throughput, and lower resource cost resulting from a dynamic allocation of quantum resources; resource partitioning performed, for example, by selecting/isolating the control electronics and network infrastructure; and techniques for dividing large QPUs into multiple, smaller systems that can be offered for concurrent processing.

In one aspect, a computer program product comprises one or more tangible computer-readable storage media and program instructions stored on at least one of the one or more tangible computer-readable storage media, the program instructions executable by a processor, the program instructions comprising determining qubits of a quantum system for use in executing a given quantum program of a plurality of quantum programs; determining control electronics associated with the determined qubits; determining a set of partitions of the quantum system based on an analysis of pending jobs; allocating the qubits and the control electronics to the set of partitions of the quantum system based on the analysis of pending jobs; and running the quantum programs using the allocated qubits. The technical benefits include improved system utilization, higher job throughput, and lower resource cost resulting from a dynamic allocation of quantum resources; resource partitioning performed, for example, by selecting/isolating the control electronics and network infrastructure; and techniques for dividing large QPUs into multiple, smaller systems that can be offered for concurrent processing.

In one aspect, a system comprises a memory and at least one processor, coupled to the memory, and operative to perform operations comprising determining qubits of a quantum system for use in executing a given quantum program of a plurality of quantum programs; determining control electronics associated with the determined qubits; determining a set of partitions of the quantum system based on an analysis of pending jobs; allocating the qubits and the control electronics to the set of partitions of the quantum system based on the analysis of pending jobs; and running the quantum programs using the allocated qubits. The technical benefits include improved system utilization, higher job throughput, and lower resource cost resulting from a dynamic allocation of quantum resources; resource partitioning performed, for example, by selecting/isolating the control electronics and network infrastructure; and techniques for dividing large QPUs into multiple, smaller systems that can be offered for concurrent processing.

In one example embodiment, the determining of the set of partitions of the quantum system includes determining whether the given quantum program fits into an existing partition; placing the given quantum program into the existing partition in response to determining that the given quantum program fits into the existing partition; identifying any quantum programs of the plurality of quantum programs that would fit into the existing partition; and preparing processes for all the quantum programs in the existing partition. The technical benefits include an enhancement of the above advantages with improved usage of the existing partitions.

In one example embodiment, the determining of the set of partitions of the quantum system includes determining whether the given quantum program fits into an existing partition; clearing all partitions of the set of partitions and beginning creating a new partitioning scheme in response to determining that the given quantum program does not fit into the existing partition; identifying any quantum programs of the plurality of quantum programs that would fit into the new partitioning scheme; and preparing processes for all the quantum programs in the new partitioning scheme. The technical benefits include an enhancement of the above advantages by enabling a repartitioning of existing partitions.

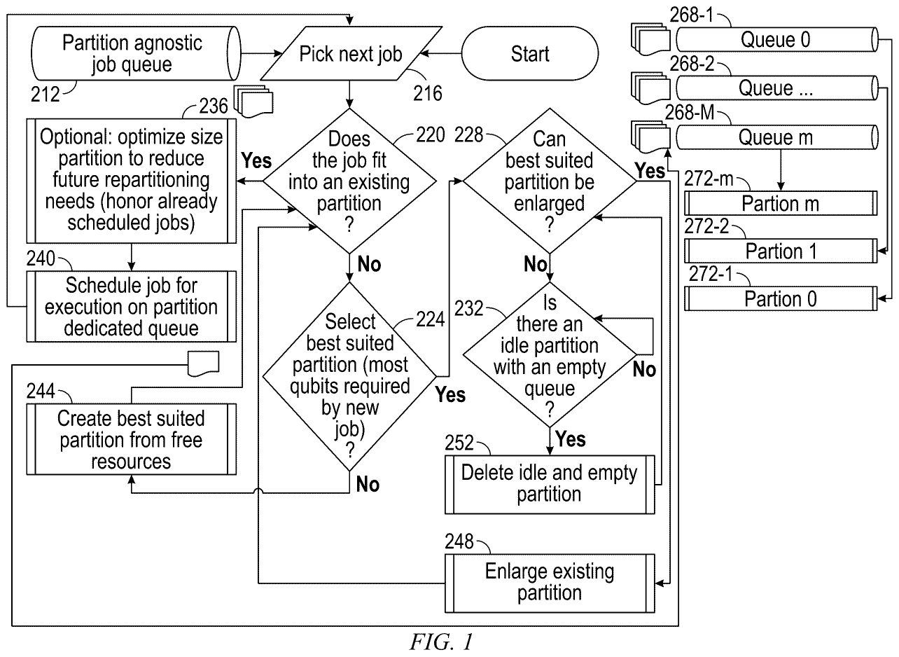

In one example embodiment, the determining of the set of partitions of the quantum system includes: (see, FIG. 1) selecting a next job from a queue 212 (operation 216); determining if the selected next job fits into an existing partition (decision block 220); and, in response to the selected next job fitting into the existing partition, reducing a partition to a minimal required size (honor already scheduled jobs; operation 236) and scheduling a job for execution (operation 240). The technical benefits include making the system more efficient by using a minimal amount of resources for a partition.

In one example embodiment, the determining of the set of partitions of the quantum system includes: (see, FIG. 1) selecting a next job from a queue 212 (operation 216); determining if the selected next job fits into an existing partition (decision block 220); and in response to the selected job not fitting into the existing partition, determining if a best suited partition was selected (most qubits required by new job; decision block 224). The technical benefits include minimizing the need to repartition the system in the future and minimizing the cost of enlarging a partition.

In one example embodiment, the method further comprises, in response to the best suited partition not being selected, creating the best suited partition from free resources (operation 244) and repeating the determining if the selected job fits into the existing partition (decision block 220). The technical benefits include minimizing the need to repartition when a best suited partition does not exist.

In one example embodiment, the method further comprises: in response to the best suited partition being selected, performing a check to determine if the best suited partition can be enlarged (decision block 228); and in response to determining that the best suited partition is enlargeable, enlarging the existing partition (operation 248) and repeating the determining if the selected job fits into the existing partition (decision block 220). The technical benefits include minimizing the need to repartition the system in the future and minimizing the cost of enlarging a partition.

In one example embodiment, the method further comprises, in response to the best suited partition being selected, performing a check to determine if the best suited partition can be enlarged (decision block 228); in response to determining that the best suited partition is not enlargeable, performing a check to determine if there is an idle partition with an empty queue (decision block 232); and in response to there being an idle partition with the empty queue, deleting the idle and empty partition (operation 252) and repeating the performing the check to determine if the best suited partition can be enlarged (decision block 228). The technical benefits include making the system more efficient by freeing idle resources for assignment to active partitions.

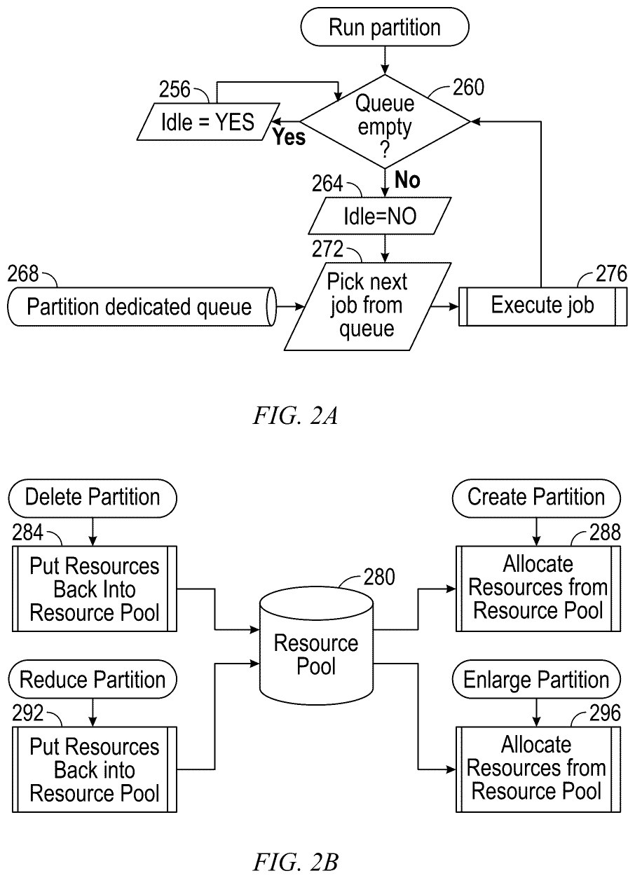

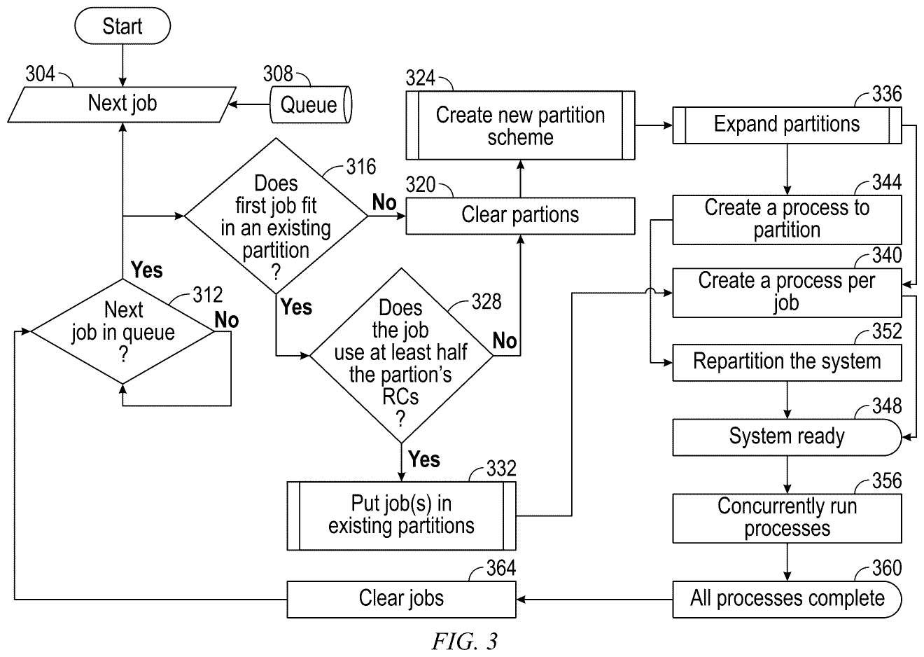

In one example embodiment, the method further comprises running a task that executes jobs in the dedicated queues per partition, and the running of the task further includes: (execute Scheduled Workload: see, FIG. 2A) performing a check to determine if the queue for a corresponding partition is empty (decision block 260); and in response to determining that the queue for the corresponding partition is empty, setting idle to YES (operation 256) and repeating the performing the check to determine if the queue for the corresponding partition is empty (decision block 260). The technical benefits include making the system more efficient by freeing idle resources for assignment to active partitions.

In one example embodiment, the method further comprises running a task that executes jobs in the dedicated queues per partition, and the running of the task further comprising: (execute Scheduled Workload: see, FIG. 2A) performing a check to determine if the queue for a corresponding partition is empty (decision block 260); and in response to determining that the queue for the corresponding partition is not empty, setting idle to NO (operation 264), selecting the next job from the queue (operation 272), executing the job (operation 276) and repeating the performing the check to determine if the queue is empty (decision block 260). The technical benefits include maintaining a high utilization of the system's qubits.

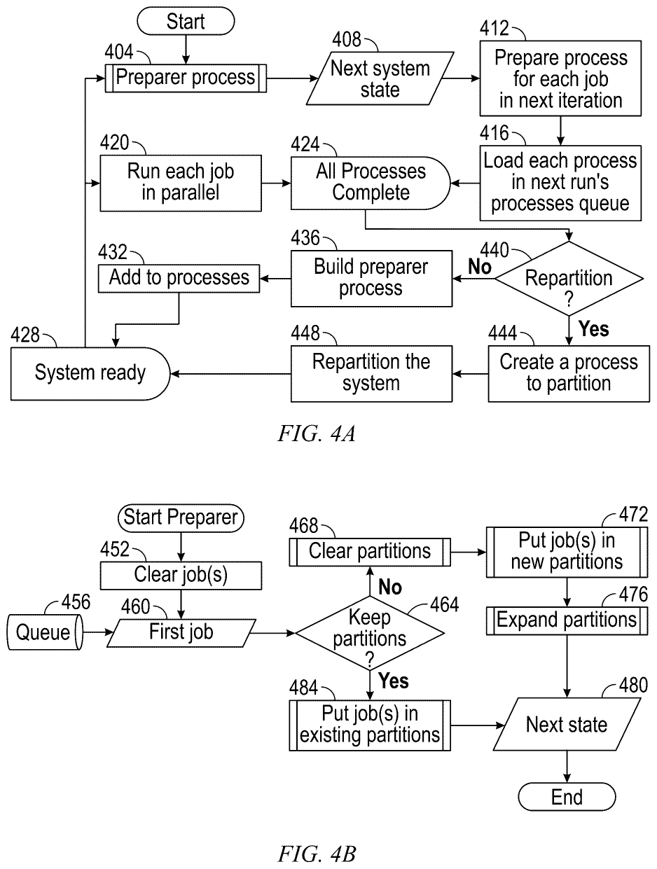

In one example embodiment, the determining of the set of partitions of the quantum system includes: (partitioning algorithm A, see, FIG. 3) retrieving a first program from a program queue 308 (operation 304); determining if the retrieved first program fit into an existing partition (decision block 316); and in response to the retrieved program not fitting into the existing partition, clearing a set of the partitions (operation 320), putting the program into a new partition (operations 324), expanding the partitions (operation 336), creating a process to implement the partition (operation 344) and creating a process per program (operation 340). The technical benefits include repartitioning the system to improve the system utilization.

In one example embodiment, the determining of the set of partitions of the quantum system includes: (partitioning algorithm A, see, FIG. 3) retrieving a first program from a program queue 308 (operation 304); determining if the retrieved first program fit into an existing partition (decision block 316); and in response to the retrieved first program fitting into the existing partition and the retrieved program using at least half the partition's readout-cards, putting the retrieved program into the existing partition (operation 332) and creating a process per program (operation 340). The technical benefits include utilizing a system configuration without repartitioning when the present configuration is suitable for the next job.

In one example embodiment, the method further comprises: repartitioning the quantum system (operation 352) after the creating the process to implement the partition (operation 344); and running the processes (operation 356) after repartitioning the quantum system (operation 352) and clearing the run programs after the processes are run (operation 364). The determining of the set of partitions of the quantum system includes: (Partitioning algorithm A FIG. 3) retrieving a first program from a program queue 308 (operation 304); determining if the retrieved first program fits into an existing partition (decision block 316); and, in response to the retrieved first program fitting into the existing partition and the program not using the at least half the partition's readout-cards, clearing the partitions (operation 320). The technical benefits include repartitioning the system to improve the system utilization when at least half the partition's readout-cards are not being utilized.

In one example embodiment, the method further comprises determining if the program queue 308 is empty (decision block 312) and retrieving another program from the program queue 308 in response to determining that the queue 308 is not empty (operation 304); and the determining of the set of partitions of the quantum system includes: (partitioning algorithm A; see, FIG. 3) retrieving a first program from a program queue 308 (operation 304); determining if the retrieved first program fits into an existing partition (decision block 316); and, in response to the retrieved first program fitting into the existing partition and the program not using the at least half the partition's readout-cards, clearing the partitions (operation 320). The technical benefits include repartitioning the system to improve the system utilization when at least half the partition's readout-cards are not being utilized.

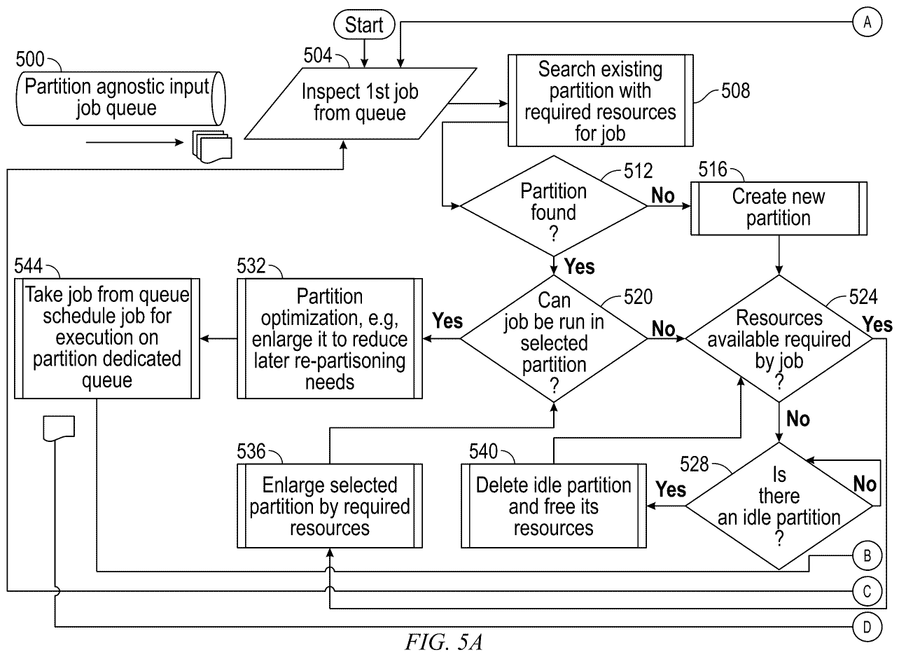

In one example embodiment, the determining of the set of partitions of the quantum system includes: (Algorithm B; see, FIGS. 4A-4B) running a preparer process (operation 404); accessing a next system state (operation 408); preparing a process for each program scheduled in a next iteration (operation 412); loading each process into the queue 308 of a next run (operation 416); performing, in response to determining that the queue 308 is empty, a check to determine if repartitioning is to be performed (decision block 440); and, in response to determining that repartitioning is to be performed, creating a process to partition (operation 444) and repartitioning the quantum system (operation 448). The technical benefits include repartitioning the system to improve the system utilization and maintaining a flow of programs for processing.

In one example embodiment, the determining of the set of partitions of the quantum system includes: (Algorithm B; see FIGS. 4A-4B) running a preparer process (operation 404); accessing a next system state (operation 408); preparing a process for each program scheduled in a next iteration (operation 412); loading each process into the queue 308 of a next run (operation 416); performing, in response to determining that the queue 308 is empty, a check to determine if repartitioning is to be performed (decision block 440); and, in response to determining that repartitioning is not to be performed, building a preparer process (operation 436) and adding to the processes (operation 432). The technical benefits include maintaining a constant flow of programs for processing.

In one example embodiment, the determining of the set of partitions of the quantum system based on the analysis of pending jobs includes: inspecting a first job on an incoming job queue 500 (operation 504); performing one of identifying a candidate existing partition and creating a new partition for the first job to generate a candidate partition (operations 508-516); enlarging the candidate partition to accommodate the first job in response to the partition being insufficient to accommodate the first job (operation 536); and removing the first job from the incoming job queue 500 and assigning the first job to the candidate partition in response to the candidate partition being sufficient to accommodate the first job (operation 544). The technical benefits include defining a future partition(s) of the system while jobs are running in other independent partitions.

In one example embodiment, the determining of the set of partitions of the quantum system based on the analysis of pending jobs includes: setting a prefetched_jobs counter to zero (operation 548); inspecting a first next job in the incoming job queue 500 (operation 552); searching for an existing partition with sufficient resources for the first next job (operation 556); performing one of identifying a candidate existing partition based on the searching and creating a new partition for the first next job if sufficient resources are available for the inspected first next job (operation 576); incrementing the prefetched_jobs counter by one in response to identifying the candidate existing partition or creating the new partition for the first next job (operation 584); and inspecting one of a second next job in the incoming job queue 500 and a new first job in the incoming job queue 500 based on a value of the prefetched_jobs counter compared to a given threshold (operations 504, 552, 580). The technical benefits include defining a future partition(s) of the system while jobs are running in other independent partitions.

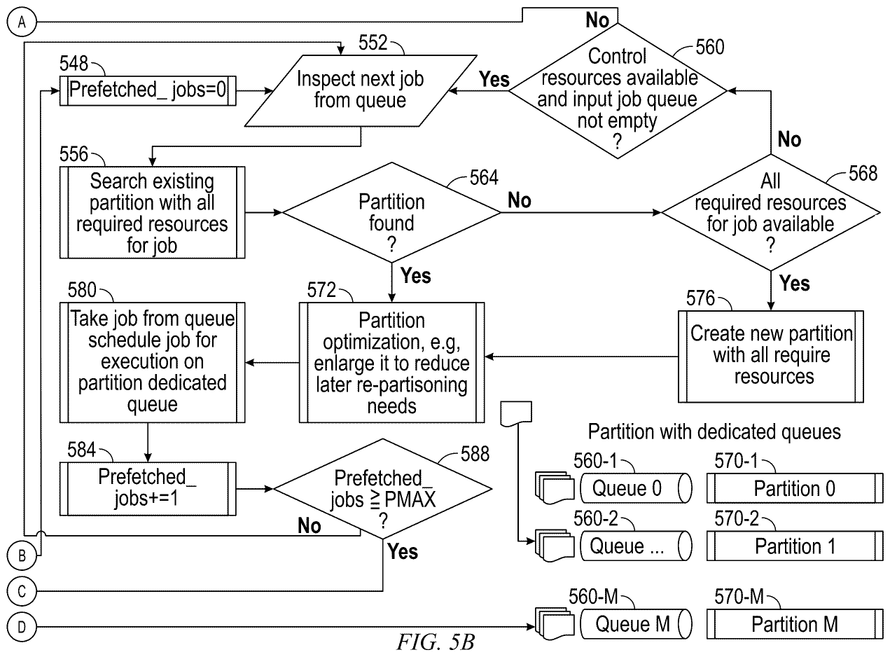

In example embodiments, a timer is used in place of the prefetched_jobs counter to ensure that a job is not left in the incoming job queue 500 for an extended period of time. The timer is started when the method begins the operations of FIG. 5B and returns to operation 504 after the timer expires. Other mechanisms for ensuring that a job is not left in the incoming job queue 500 for an extended period of time are also contemplated.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improved system utilization, higher job throughput, and lower resource cost resulting from a dynamic allocation of quantum resources;
resource partitioning performed, for example, by selecting/isolating the control electronics and network infrastructure (as opposed to configuring a quantum processing unit (QPU) or circuitry inside a device; the selecting/isolating may be implemented using firmware);
a resource partitioning technique that is easily extensible to analog computers in general;
partitioning of a quantum computer by partitioning room-temperature electronic components, such as the drive-cards (DCs), readout-cards (RCs), partition-controllers (PCs) and network infrastructure components (NICs) used to control and read out parts of the quantum processing unit (QPU);
avoidance of re-partitioning in certain instances by attempting to fit a next set of programs into an existing partitioning;
techniques for dividing large QPUs into multiple, smaller systems that can be offered for concurrent processing;
performance of maintenance tasks on groups of qubits on a regular basis (e.g., isolate a subset of qubits and perform maintenance); and
techniques for dividing a quantum computer into a number of different quantum systems for the purposes of calibrating or testing the entire system more efficiently.

As used herein, a “quantum bit” (qubit) is a quantum two-level system used to carry out quantum gates, the basic operations of quantum computing. A real-time architecture (RTA) is a distributed system consisting of one or several central processing units (CPUs), of which one or multiple CPUs are enriched with facilities to send or receive signals for qubit control or readout. The CPUs are connected by a classical computer network and typically share a common synchronized time base. The RTA, such as a combination of classical computing resources like CPUs, a network to connect them and facilities to send signals to control qubits, facilitates hybrid computing possible. It orchestrates quantum gates, generates waves for qubit control/readout, and processes measured qubit data. A partition-mask is a resource in the control electronics preventing a partition to see/modify other partitions qubit readout information. (The RTA provides facilities to trigger certain things in parallel, e.g., sending and reading analog waves to different qubits at defined moments in time. Within each CPU, there is a notion of time which is synchronized across all controllers. Messages which indicate at which point in time certain activities must be performed are exchanged.) In one example embodiment, when partitioning or executing multiple quantum programs in parallel, one RTA is used for each partition/program such that the job flow can be controlled independently. Combining multiple real-time-controllers within their own configurable network is induced by the desire to scale the system. The RTA can consist of one or multiple CPUs.)

As quantum computers increase in size, new systems will be deployed that are larger than many of the quantum programs that are intended to be run on these systems. To use the quantum computers more efficiently, it is possible to partition the control electronics of these systems to allow programs to run concurrently. Generally, systems, methods and techniques are disclosed for efficiently performing a dynamic partitioning of the quantum system based upon the resource needs of the programs that are queued to run. In one example embodiment, a large QPU is divided into multiple, smaller systems that can be offered for running programs concurrently. In one example embodiment, a quantum computer is divided into a number of different quantum systems for the purposes of calibrating or testing the entire system more efficiently.

### Quantum Computer Partitioning

At the room-temperature electronics (RTE) level, partitioning a quantum computer refers to grouping specific drive cards (DCs) with specific readout cards (RCs) and assigning those DC-RC groups to a particular partition controller (PC). Beyond the RTE level, this act is equivalent to combining the qubits associated with those DCs into a single quantum system that operates independently from other partitions on the same overall system. This partitioning can be performed statically, where the composition of a partition is pre-planned prior to being applied, or dynamically, where the composition of a partition is not pre-planned. In the dynamic case, qubits are circumstantially allocated to specific partitions based on real-time conditions, by assigning appropriate DC-RC groups to the same PC.

### Problem Statement

If a qubit can be constructed from patterned superconductors, it will be easy to scale. (It is noted that the use of other types of qubits, including quantum-wells qubits, spin-qubits and the like, is contemplated.) Traditionally, quantum processing units (QPUs) are offered as a single, large portion, but the sharing of RTE equipment between multiple QPUs can occur. While this can, at times, involve dividing a single QPU into multiple partitions, a more common use of partitioning involves using one suite of RTE equipment for multiple QPUs to reduce hardware requirements. Although the ultimate goal would be to achieve dynamic partitioning, the following three steps are recognized as tasks that need to be accomplished in order for this to occur:
1. a single static partitioning of the entire QPU;
2. implementing pre-planned, static partitioning schemes of the QPU for specific situations (e.g. calibration); and
3. dynamic partitioning of the QPU for optimally utilizing the existing resources.

In one example embodiment, a queue of quantum jobs is accessed, where an individual job might not need the entire set of resources provided by the quantum-computer, and a smart partitioning of the controlling resources is determined which allows a maximum number of the quantum jobs to execute in parallel.

Furthermore, a new partitioning is prepared based on the next job(s) in the queue. This is similar to a double buffering effect while the first set of jobs is executed. It tries to avoid re-partitioning as much as possible by attempting to fit the next set of jobs into the existing partitioning.

In one example embodiment, the partitioning of the system is not performed by configuring the quantum processing unit (QPU) itself but by partitioning/isolating the control electronics based on the qubits needed by the algorithms which are to run inside each partition. If some resources remain unused after a partitioning has been applied, already-created partitions are automatically enlarged, anticipating that this avoids re-partitioning as much as possible.

### Partitioning of a Quantum Processing Unit (QPU) by Partitioning the Control Electronics

In one example embodiment, a set of control electronics is determined where a job or set of jobs determine the qubits being used. For each qubit, the control electronics, such as drive-card(s), readout-card(s), and other card(s) (e.g. fast-flux cards for qubit connections) are determined. The determined control electronics are added to a set of control electronics and removed from a pool of available resources. A partition-controller (partition-id) is identified, added to the set of control electronics, and removed from the pool of available resources. Low latency network components (NICs) are identified, added to the set of control electronics, and removed from the pool of available resources. (If a job demands to control a qubit A, it should, as a consequence, control all DCs and RCs associated with the qubit A.)

The control resources are then configured. For all instruments in the set of control electronics, a partition-id and/or partition-masks are configured; and the low latency network components (such as network interface components (NICs)) are configured to route packets for a given partition identifier (ID). It is noted that there can be additional hardware components required for dynamic partitioning, especially including any resource needed to control partition sensitive packet routing, such as registers, tables, and the like, that need to be implemented in a manner to allow disjunct partition traffic to continue flowing while a reconfiguration of the hardware is done for the sake of adding, removing, and resizing a partition. It is appropriate to ensure that the hardware allows reconfiguration to add/delete packet routing capabilities for one partition while other partitions in the system continue to run without any impact. This is a special requirement which static partitioning does not have since, in the static case, there is no traffic in the system while it is being reconfigured.

### Partition Operations

In one example embodiment, the partition operations include:
1. Create-Partition: assign a set of system resources to a partition that are needed to control a set of qubits;
2. Delete-Partition: free the set of system resources associated with the deleted partition;
3. Enlarge-Partition: add more system resources to a partition to enable the control of additional qubits; and
4. Reduce-Partition: free a subset of partition resources to reduce the number of qubits associated with the partition.

### Manage Incoming Workload

FIG. 1 is a flowchart for managing incoming workloads and partitions to allow jobs to be executed efficiently, in accordance with an example embodiment. The management of partitions includes creating, deleting, and resizing partitions. In one example embodiment, the next job is selected from the queues 212 (operation 216). A check is performed to determine if the selected job fits into an existing partition (decision block 220). If the selected job fits into an existing partition (YES branch of decision block 220), the partition can be optimized (e.g. minimizing the number of resources to control the qubits needed by the jobs in the queue, or even enlarging the partition to contain control resources for qubits which are neighbors of the already used control resources; the intent is to avoid reconfiguration of the partition for subsequent jobs; operation 236), the job is scheduled for execution (operation 240) and the method proceeds with operation 216.

Different strategies can be applied for selecting the next job. When implementing a selection strategy, it is appropriate to ensure that jobs are not starving for service or staying in the queue for too long. Selecting a job can thus depend on a fairness policy if there are different job owners feeding into the same queue.

In one example embodiment, the topmost job in the queue (that is, the oldest job in the queue) is selected. To avoid blocking when the second job needs the same resources as the first job, the topmost job is selected, but this is enhanced by selecting a set of subsequent jobs which can be fit into the existing partition or into a partitioning which can be created with the given resources. This also allows for temporarily skipping jobs which do not fit into the candidate partitioning. The number of jobs that can be selected (in addition to the first job) depends, for example, on available queuing resources, e.g. managing a finite length of the partition queues. It can be determined heuristically by the skilled artisan, given the teachings herein.

Returning to FIG. 1, if the selected job does not fit into an existing partition (NO branch of decision block 220), a check is performed to determine if the best suited partition was selected (the smallest partition which has at least the number of qubits needed for the selected job; decision block 224). (A partition which can be enhanced, if necessary, with the minimal effort to match the requirements of the to be executed job is thus selected. This is often the partition which already has most of the resources to control the desired qubits (such as the DCs, RC, and the like). If a job demands to control a qubit A, it must, as a consequence, control all DCs and RCs associated with the qubit A. Furthermore, those resources must be accessible by the PC controlling the jobs execution.) If the best suited partition was not selected (NO branch of decision block 224), the best suited partition is created from free resources (operation 244) and the method proceeds with decision block 220. If the best suited partition was selected (YES branch of decision block 224), a check is performed to determine if the best suited partition can be enlarged (decision block 228).

If the best suited partition can be enlarged (such as, when resources for the enlargement are available) (YES branch of decision block 228), the existing partition is enlarged (operation 248) and the method proceeds with decision block 220. If the best suited partition cannot be enlarged (NO branch of decision block 228), a check is performed to determine if there is an idle partition with an empty jobs queue (decision block 232). If there is an idle partition with an empty queue (YES branch of decision block 232), the idle and empty partition is deleted (operation 252) and the method proceeds with decision block 228. If there is no idle partition with an empty queue (NO branch of decision block 232), wait until a sufficiently large partition becomes available (as a result of a job(s) being completed). (In general, “idle” refers to a state of the partition. “Idle and empty” is a partition which is in the idle state and not scheduled to run any jobs. This could be a partition which finished the job(s) it was running and, as a result, has no queued jobs. Basically, the algorithm keeps checking if there are partitions which have empty queues and frees the resources of those partitions. Once enough resources are available, these will be combined into a new partition for the current job to run on.)

### Execute Scheduled Workload

FIG. 2A is a flowchart for a task that executes jobs in the dedicated queues of each partition, in accordance with an example embodiment. In one example embodiment, a separate queue is created for each partition: as long as there are “matching jobs” for a given partition, they are queued up for that partition specifically. A partition process is run and a check is performed to determine if the queue for the corresponding partition is empty (decision block 260). If the queue is empty (YES branch of decision block 260), idle is set to YES (operation 256) and the method proceeds with decision block 260. If the queue is not empty (NO branch of decision block 260), idle is set to NO (operation 264), the next job is selected from the queue 268 (operation 272), the selected job is executed (operation 276) and the method proceeds with decision block 260.

FIG. 2B is a flowchart for managing partitions of a quantum processor, in accordance with an example embodiment. In one example embodiment, the delete partition process includes putting resources back into the resource pool 280 when a partition is idle and the corresponding queue is empty (operation 284). In one example embodiment, the reduce partition process includes putting resources back into the resource pool 280 when they are no longer needed (operation 292). In one example embodiment, the enlarge partition process includes allocating extra resources from the resource pool 280 to a partition when they are available (operation 296). In one example embodiment, the create partition process includes allocating resources from the resource pool 280 to a new partition (operation 288).

Two algorithms (see, FIGS. 3 and 4A-4B) are introduced for partitioning a quantum processor. In general, there are six common steps between the two algorithms, including:
1. determining whether the first quantum job in the queue fits into an existing partition;
2. if the first quantum job in the queue fits into an existing partition, placing the job into that partition; if the first quantum job in the queue does not fit into an existing partition, clear all partitions and begin creating a new partitioning scheme;
3. examining the rest of the jobs in the queue, and identifying any jobs that would fit into existing or new partitions based upon the previous step;
4. preparing processes for all the jobs;
5. repartitioning (if necessary); and
6. running the jobs concurrently.

Both algorithms (see, FIG. 3 and FIGS. 4A-4B) share subroutines that remain unchanged between them, including:
placing jobs into existing partitions;
placing jobs into new partitions; and
expanding partitions.

### Placing Programs into Existing Partitions

Whenever the first job in the queue fits into an existing partition, jobs will be placed into the existing partitions.

### Placing Programs into New Partitions

If the first program does not fit into an existing partition, the system should be repartitioned. In that case, instead of checking whether jobs will fit into existing partitions, jobs need to be compared to unallocated space that will be left after partitioning has taken place for jobs that are included in the next set of jobs to be run.

### Expanding Partitions

If new partitions will be created, there will likely be portions of the quantum computer that remain unallocated. To maximize the size of partitions and minimize the probability of repartitioning during the next set of jobs, the new partitions that are to be created should be expanded so that the entire QPU is allocated.

### Partitioning Algorithm A

In the first part of Algorithm A, repartitioning occurs concurrently with preparing processes for each quantum job. In the second part, the jobs are all run concurrently.

### Partitioning Algorithm B

Algorithm B differs from Algorithm A by preparing the processes for the next set of jobs in parallel to running quantum jobs. Since preparing the processes is the most time-consuming overhead task, running this task concurrently to the quantum jobs should significantly reduce overhead. The reduction in overhead from the additional concurrency should, in theory, increase the speed up. As a trade-off, this approach is more complex to implement than Algorithm A. Additionally, a new process is designed to carry out the task of creating the processes for the next set of jobs.

FIG. 3 is a flowchart for a first example method for partitioning a quantum computer, in accordance with an example embodiment. The technique of FIG. 3 deletes all partitions before starting a new partitioning scheme. As illustrated in FIG. 3, the first job is retrieved from the general program queue 308 (operation 304). A check is performed to determine if the first job fits into an existing partition (decision block 316). If the first job fits into an existing partition (YES branch of decision block 316), a check is performed to determine if the first job uses at least half the partition's RCs (decision block 328); otherwise (NO branch of decision block 316), the partitions are cleared (operation 320), a new minimal partition scheme is created (where minimal means minimum number of qubits required to execute the job(s) (operation 324), the partitions are expanded (operation 336), a process to implement the partition(s) is created (operation 344) and a process per job is created (operation 340). (Once the partition is available, the already prepared job can be run on the partition.) In determining the amount of expansion to implement for a partition, in the simplest case, the remaining resources are distributed equally to the partitions. In one example embodiment, partitions are enlarged based on the distribution of the number of qubits required by jobs in the past. For example, if there are 10 qubits in the qubit processor, the next jobs may require that one partition include 2 qubits and another partition include 5 qubits to be sufficient for the next few jobs. If, from past experience, it is known that jobs requiring 7 or 3 qubits are common, the partitions would be enlarged accordingly.

If the first job does not use at least half the partition's RCs (NO branch of decision block 328), the partitions are cleared (operation 320) and the method proceeds with operation 324; otherwise (YES branch of decision block 328), the first job (and the next job(s) that will fit into the existing partition scheme) are assigned to the existing partition scheme (such as the smallest existing partition which satisfies the requirements specified by the job) (operation 332), and a process per job is created (operation 340). The system is then ready 348. It is noted that the threshold of “half the partition's RCs” is programmable; a smaller threshold may be selected if the partitioning cost is reduced.

Returning to operation 344, following the creation of a process to partition, the partition layout is applied to the system (operation 352). The system is then ready 348.

Following the identification of the system being identified as being ready, the processes are concurrently run (operation 356). Once operation 356 is complete, all processes are then complete 360 and the jobs are cleared from the qubit processor (operation 364). A check is performed to determine if a next program is in the queue 308 (decision block 312). If there is a next program is in the queue 308 (YES branch of decision block 312), the next program is retrieved from the general program queue 308 (operation 304); otherwise (NO branch of decision block 312), operation 312 is repeated.

### Algorithm B

FIGS. 4A-4B are a flowchart for a second example method for partitioning a quantum computer, in accordance with an example embodiment. The method of FIGS. 4A-4B uses additional concurrency to further reduce overhead in comparison to Algorithm A. As illustrated in FIG. 4A, a preparer process is run (operation 404) and a next system state is accessed (operation 408). A process is prepared for each job scheduled in the next iteration (operation 412) and each process is loaded into the next run's process queue(s) (operation 416). Once all processes are complete 424, a check is performed to determine if repartitioning is to be performed (decision block 440). If repartitioning is to be performed (YES branch of decision block 440), a process to partition is created (operation 444) and the system is repartitioned (operation 448). The system is then ready 428 and the jobs are run in parallel (operation 420). Otherwise, (NO branch of decision block 440), the preparer process is built (operation 436; as described further by way of example in conjunction with FIG. 4B) and the processes are added to (operation 432). The system is then ready 428.

Once the system is ready (partitioned for a set of jobs to run on multiple partitions in parallel) 428, these jobs will execute and, in parallel, a partitioning scheme for the next set of jobs is determined by the preparer process.

As illustrated in FIG. 4B, a preparer process is started and all programs are cleared (operation 452). A first program is retrieved from the general program queue 456 (operation 460). A check is performed to determine if the partitions should be kept (decision block 464). If the partitions should be kept (YES branch of decision block 464), the first job (and the next job(s) that will fit into the partitions) are put into an existing partition(s) (operation 484) and the next state is accessed (operation 480). The method then ends.

If the partitions should not be kept (NO branch of decision block 464), the partitions are cleared (operation 468), the job(s) are put into new partitions (operation 472), the partitions are expanded (operation 476) and the method proceeds with operation 480.

FIGS. 5A-5B are a flowchart for a third example method for managing partitions of a quantum processor, in accordance with an example embodiment. One task of FIGS. 5A-5B is to gather jobs having a potential for parallel execution by inspecting the currently available partitions in combination with the free resources (which can be used to create new partitions or expand existing partitions). Partitions can be added, deleted and/or changed in size, assuming that there is no job in a partition to be deleted, while allowing jobs to be scheduled in that partition.

The method of FIG. 5A is responsible for inspecting the first job on the incoming job queue 500. In one example embodiment, the first (top-most) job on the incoming job queue 500 is inspected (operation 504). For this first job, it should be ensured that a partition suitable for its execution is either found, found and modified or created, as described more fully below. This is done to avoid the starving of jobs in the incoming job queue 500. Thus, an existing partition having at least some resources for the first job is searched ((operation 508). A check is then performed to determine if such a partition is found (decision block 512). If such a partition is not found (NO branch of decision block 512), a new partition is created (operation 516) and the method proceeds with operation 524; otherwise (YES branch of decision block 512), a check is performed to determine if the first job can be run in the existing partition (are resources in the partition sufficient for the first job; decision block 520). If the first job cannot be run in the existing partition (NO branch of decision block 520), the method proceeds with operation 524; otherwise, (YES branch of decision block 520), the method proceeds with operation 532.

Returning to operation 524, a check is performed to determine if sufficient resources are available to execute the first job (decision block 524). If sufficient resources are available for the first job (YES branch of decision block 524), the selected partition is enlarged with the resources required by the first job (operation 536) and the method proceeds with operation 520; otherwise, (NO branch of decision block 524), a check is performed to determine if there is an idle partition (decision block 528). If an idle partition does not exist (NO branch of decision block 528), a wait is executed and operation 528 is repeated; otherwise (YES branch of decision block 528), the resources of the idle partition are freed and the idle partition is deleted (operation 540), and the method proceeds with operation 524.

Once a partition for the execution of the first job is found and all required resources are already part of the partition, this partition can further be optimized (operation 532). In certain circumstances, proactively including control resources for qubits neighbored to the qubits which are already under control of this partition can be useful to avoid partition operations for subsequent jobs. If a partition turns out to still contain resources used for already completed jobs, it can also be useful to reduce its size to give those resources back into the free resource pool and allow for more flexibility when establishing new partitions, as described more fully below.

Following operation 532, the first job can be removed from the incoming job queue 500 and scheduled for execution in the identified partition (operation 544). The method then proceeds with the operations of FIG. 5B.

If a suitable partition for the first job was found or created and the job was scheduled for execution, the procedure will move to the method of FIG. 5B which is responsible for searching the incoming job queue 500 for jobs which can run in parallel to the first job. The procedure is similar to the method of FIG. 5A and starts with setting a prefetched_jobs counter to zero (operation 548). This is done to ensure that the procedure is enforced to return to the method of FIG. 5A once a maximum number of jobs is scheduled, such that the prefetching of jobs cannot lead to a starvation of the first job on the incoming job queue 500.

The next job in the incoming job queue 500 is inspected (operation 552). The “next job” to be scheduled can be determined using different criteria, such as oldest job, smallest job, cost (such as business-related costs) and the like. Prefetching jobs is also possible. The next job to be scheduled does not need to be the first job on the incoming job queue 500, but could be the second job, the third job, and so on.

The next step is to find or create a suitable partition with all required resources to run this job. If a partition with all required resources (such as PCs, RCs, DCs, and the like) is found, the partition optimization is done. The job is removed from the incoming job queue 500 and put onto the selected partition queue (one of queues 592-1, . . . , 592-M). The prefetched_jobs counter is increased by 1 and checked to determine if it exceeds a threshold PMAX. If the prefetched_jobs counter exceeds the threshold PMAX, the method proceeds with the method of FIG. 5A. If the prefetched_jobs counter does not exceed the threshold PMAX, a new job is inspected as a potential candidate for parallel execution.

For the case that no suitable partition could be found, the pool of free control resources (resource pool 280) is checked and, if all required resources to create a partition to run the selected job are available, a new partition is created, as described more fully below. If not all resources required for this job are found, either a different job is tried or, if there are no more free resources to create a new partition, the method proceeds with operation 504 of FIG. 5A where the first job on the incoming job queue 500 is inspected and it is ensured that an appropriate partition is made available. Since job execution in the partitions moves on in parallel, the situation the next time this path is executed can be different. Moreover, if a job fails to be selected and executed, it will, at some point in time, be the first job on the incoming job queue 500 and thus enforced to run.

An existing partition with sufficient resources for the next job is searched for (operation 556). A check is then performed to determine is such a partition is found (decision block 564). If such a partition is not found (NO branch of decision block 564), a check is performed to determine if sufficient resources are available for the next job (decision block 568); otherwise (YES branch of decision block 564), the method proceeds with operation 572.

If sufficient resources are available for the next job (YES branch of decision block 568), a new partition with sufficient resources is created (operation 576) and the method proceeds with operation 572; otherwise (NO branch of decision block 568), a check is performed to determine if control resources are available and if the incoming job queue 500 is not empty (decision block 560). If control resources are available and the incoming job queue 500 is not empty (YES branch of decision block 560), the method proceeds with operation 556; otherwise (NO branch of decision block 560), the method proceeds with operation 504.

Returning to operation 572, once a partition for the execution of the next job is found and all required resources are already part of the partition, this partition can further be optimized (operation 572), as described more fully above. The next job can be removed from the incoming job queue 500 and scheduled for execution in the identified partition (operation 580). The prefetched_jobs counter is incremented (operation 584) and a check is performed to determine if the prefetched_jobs counter is greater than or equal to PMAX (decision block 588). If the prefetched_jobs counter is greater than or equal to PMAX (YES branch of decision block 588), the method proceeds with operation 504; otherwise (NO branch of decision block 588), the method proceeds with operation 552. PMAX is a limit on the number of jobs to be processed while a job is facing starvation in the queue. For example, PMAX may be set equal to seven.

### Maintenance of Qubits

In one example embodiment, the controlling resources for a set of qubits are partitioned into groups where one partition undergoes maintenance, such as testing the performance of the qubits, while other partitions are used to process non-maintenance jobs. In example embodiments, maintenance jobs are given priority over non-maintenance jobs.

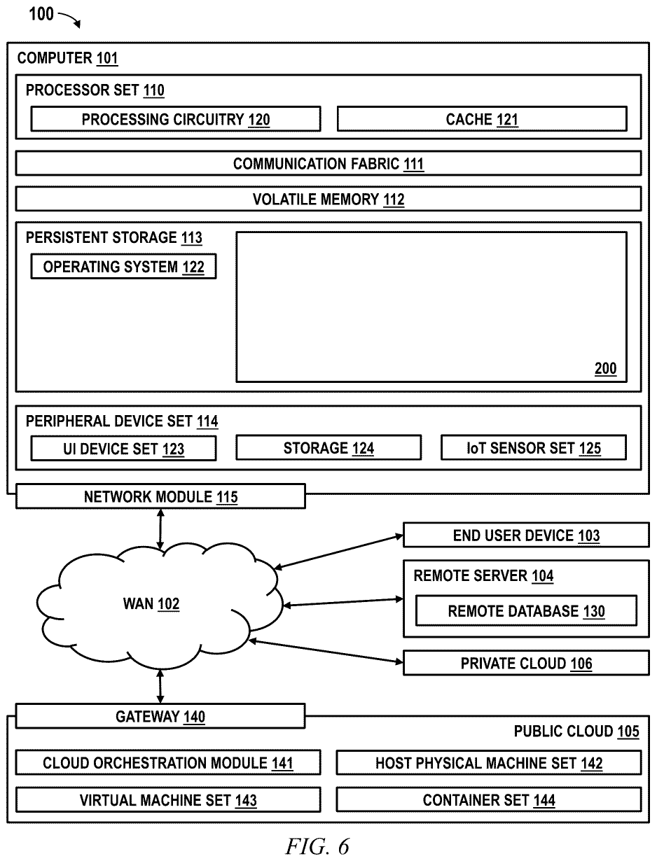

Refer now to FIG. 6.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as quantum computer manager 200 (e.g., software aspects of partitioning techniques disclosed herein executing on a conventional, quantum, or hybrid computing architecture). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
determining qubits of a quantum system for use in executing a given quantum program of a plurality of quantum programs;
determining control electronics associated with the determined qubits;
determining a set of partitions of the quantum system based on an analysis of pending jobs;
allocating the qubits and the control electronics to the set of partitions of the quantum system based on the analysis of pending jobs; and
running the quantum programs using the allocated qubits.

2. The method of claim 1, wherein the determining of the set of partitions of the quantum system includes:
determining whether the given quantum program fits into an existing partition;
placing the given quantum program into the existing partition in response to determining that the given quantum program fits into the existing partition;
identifying any quantum programs of the plurality of quantum programs that would fit into the existing partition; and
preparing processes for all the quantum programs in the existing partition.

3. The method of claim 1, wherein the determining of the set of partitions of the quantum system includes:
determining whether the given quantum program fits into an existing partition;
clearing all partitions of the set of partitions and beginning creating a new partitioning scheme in response to determining that the given quantum program does not fit into the existing partition;
identifying any quantum programs of the plurality of quantum programs that would fit into the new partitioning scheme; and
preparing processes for all the quantum programs in the new partitioning scheme.

4. The method of claim 1, wherein the determining of the set of partitions of the quantum system includes:
selecting a next job from a queue;
determining if the selected next job fits into an existing partition; and
in response to the selected next job fitting into the existing partition, reducing a partition to a minimal required size and scheduling a job for execution.

5. The method of claim 1, wherein the determining of the set of partitions of the quantum system includes:
selecting a next job from a queue;
determining if the selected next job fits into an existing partition; and
in response to the selected job not fitting into the existing partition, determining if a best suited partition was selected.

6. The method of claim 5, further comprising, in response to the best suited partition not being selected, creating the best suited partition from free resources and repeating the determining if the selected job fits into the existing partition.

7. The method of claim 5, further comprising:
in response to the best suited partition being selected, performing a check to determine if the best suited partition can be enlarged; and
in response to determining that the best suited partition is enlargeable, enlarging the existing partition and repeating the determining if the selected job fits into the existing partition.

8. The method of claim 5, further comprising, in response to the best suited partition being selected, performing a check to determine if the best suited partition can be enlarged;
in response to determining that the best suited partition is not enlargeable, performing a check to determine if there is an idle partition with an empty queue; and
in response to there being an idle partition with the empty queue, deleting the idle and empty partition and repeating the performing the check to determine if the best suited partition can be enlarged.

9. The method of claim 4, further comprising running a task that executes jobs in the dedicated queues per partition, the running of the task further comprising:
performing a check to determine if the queue for a corresponding partition is empty; and
in response to determining that the queue for the corresponding partition is empty, setting idle to YES and repeating the performing the check to determine if the queue for the corresponding partition is empty.

10. The method of claim 4, further comprising running a task that executes jobs in the dedicated queues per partition, the running of the task further comprising:
performing a check to determine if the queue for a corresponding partition is empty; and
in response to determining that the queue for the corresponding partition is not empty, setting idle to NO, selecting the next job from the queue, executing the job and repeating the performing the check to determine if the queue is empty.

11. The method of claim 1, wherein the determining of the set of partitions of the quantum system includes:
retrieving a first program from a program queue;
determining if the retrieved first program fit into an existing partition; and
in response to the retrieved program not fitting into the existing partition, clearing a set of the partitions, putting the program into a new partition, expanding the partitions, creating a process to implement the partition and creating a process per program.

12. The method of claim 1, wherein the determining of the set of partitions of the quantum system includes:
retrieving a first program from a program queue;
determining if the retrieved first program fit into an existing partition; and
in response to the retrieved first program fitting into the existing partition and the retrieved program using at least half the partition's readout-cards, putting the retrieved program into the existing partition and creating a process per program.

13. The method of claim 1, further comprising:
repartitioning the quantum system after the creating the process to implement the partition; and
running the processes after repartitioning the quantum system and clearing the run programs after the processes are run; and
wherein the determining of the set of partitions of the quantum system includes:
retrieving a first program from a program queue;
determining if the retrieved first program fits into an existing partition; and
in response to the retrieved first program fitting into the existing partition and the program not using the at least half the partition's readout-cards, clearing the partitions.

14. The method of claim 1, further comprising determining if the program queue is empty and retrieving another program from the program queue in response to determining that the queue is not empty; and
wherein the determining of the set of partitions of the quantum system includes:
retrieving a first program from a program queue;
determining if the retrieved first program fits into an existing partition; and
in response to the retrieved first program fitting into the existing partition and the program not using the at least half the partition's readout-cards, clearing the partitions.

15. The method of claim 1, wherein the determining of the set of partitions of the quantum system includes:
running a preparer process;
accessing a next system state;
preparing a process for each program scheduled in a next iteration;
loading each process into the queue of a next run;
performing, in response to determining that the queue is empty, a check to determine if repartitioning is to be performed; and
in response to determining that repartitioning is to be performed, creating a process to partition and repartitioning the quantum system.

16. The method of claim 1, wherein the determining of the set of partitions of the quantum system includes:
running a preparer process;
accessing a next system state;
preparing a process for each program scheduled in a next iteration;
loading each process into the queue of a next run;
performing, in response to determining that the queue is empty, a check to determine if repartitioning is to be performed; and
in response to determining that repartitioning is not to be performed, building a preparer process and adding to the processes.

17. The method of claim 1, wherein the determining of the set of partitions of the quantum system based on the analysis of pending jobs includes:
inspecting a first job on an incoming job queue;
performing one of identifying a candidate existing partition and creating a new partition for the first job to generate a candidate partition;
enlarging the candidate partition to accommodate the first job in response to the partition being insufficient to accommodate the first job; and
removing the first job from the incoming job queue and assigning the first job to the candidate partition in response to the candidate partition being sufficient to accommodate the first job.

18. The method of claim 17, wherein the determining of the set of partitions of the quantum system based on the analysis of pending jobs includes:
setting a prefetched_jobs counter to zero;
inspecting a first next job in the incoming job queue;
searching for an existing partition with sufficient resources for the first next job;
performing one of identifying a candidate existing partition based on the searching and creating a new partition for the first next job if sufficient resources are available for the inspected first next job;
incrementing the prefetched_jobs counter by one in response to identifying the candidate existing partition or creating the new partition for the first next job; and
inspecting one of a second next job in the incoming job queue and a new first job in the incoming job queue based on a value of the prefetched_jobs counter compared to a given threshold.

19. A computer program product, comprising:
one or more tangible computer-readable storage media and program instructions stored on at least one of the one or more tangible computer-readable storage media, the program instructions executable by a processor, the program instructions comprising:
determining qubits of a quantum system for use in executing a given quantum program of a plurality of quantum programs;
determining control electronics associated with the determined qubits;
determining a set of partitions of the quantum system based on an analysis of pending jobs;
allocating the qubits and the control electronics to the set of partitions of the quantum system based on the analysis of pending jobs; and
running the quantum programs using the allocated qubits.

20. A system comprising:
a memory; and
at least one processor, coupled to said memory, and operative to perform operations comprising:
determining qubits of a quantum system for use in executing a given quantum program of a plurality of quantum programs;
determining control electronics associated with the determined qubits;
determining a set of partitions of the quantum system based on an analysis of pending jobs;
allocating the qubits and the control electronics to the set of partitions of the quantum system based on the analysis of pending jobs; and
running the quantum programs using the allocated qubits.
